(19) United States
(12) Patent Application Publication
(10) Pub. No.: US 2011/0048635 A1
(43) Pub. Date: Mar. 3, 2011

(54) RELEASE FILM MADE OF POLYOLEFIN AND USE OF THE FILM

(75) Inventors: Bernhard Müssig, Seevetal (DE); Nicole Behrens, Munchen (DE)

(73) Assignee: TESA SE, Hamburg (DE)

(21) Appl. No.: 12/936,998

(22) PCT Filed: Apr. 30, 2009
(86) PCT No.: PCT/EP09/55288

§ 371 Date: Nov. 4, 2010

(30) Foreign Application Priority Data
Apr. 30, 2008 (DE) 10 2008 021 842.1

(51) Int. Cl. B32B 37/16; C09J 7/02; B32B 27/08; B32B 27/32; C08L 23/06; C08L 23/08

(52) U.S. Cl. 156/297; 428/337; 428/447; 428/523; 156/60; 525/240

(57) ABSTRACT

A separation film having at least one-layered film member that has a basic film on which other layers are optionally arranged. A release layer is applied to at least one side of the film member. The basic film contains an ethylene polymer A having a density ranging from 0.86 and 0.89 g/cm³ and a minimum crystallite melting point of at least 105° C. and an ethylene polymer B having a minimum density of 0.90 g/cm³.

The invention relates to a release film made of an at least single-layer film structure, to at least one side of which a release layer has been applied.

When adhesive tapes have been coated on one or both sides with adhesives, they are mostly wound up to give a roll in the form of an Archimedean spiral at the end of the production process. A covering material is laminated to the open adhesive mass, and is then wound up together with the adhesive tape; the purpose of this is to prevent the adhesive masses coming into contact with one another in the case of adhesive tapes that are adhesive on both sides, or to prevent adhesion of the open adhesive-mass side to the reverse side of the carrier in the case of adhesive tapes that are adhesive on one side. The person skilled in the art uses the term “liner” for these covering materials. Liners are used not only to cover adhesive tapes that are adhesive on one or both sides but also to cover labels.

A liner (release paper, release film) is not a constituent of an adhesive tape or label, but is merely an aid to production or storage thereof, or serves as an aid to the further processing of the adhesive tape/of the label, for example in punching processes. In contrast to an adhesive-tape substrate, a liner has moreover not been bonded securely to an adhesive layer.

Liners are generally release papers (papers with a silicone coating on one or both sides).

Other materials used to a small extent are films made of polyester, of propylene, or of polyethylene and which have a silicone coating. The term used by the person skilled in the art for film-based liners, when these are used for self-adhesive products, is release films—where in particular the polyolefin films are produced via blown—or flat-film extrusion.

Liners are used in the adhesive-tape-production process (coating of pressure-sensitive adhesive onto the liner, drying, transfer of the dry adhesive to a substrate, and removal of the liner). The liner can also be used for storage (for example in the case of double-sided adhesive tapes). The liner provides protective covering of the pressure-sensitive-adhesive layer, and is removed prior to adhesive bonding in the application.

Release papers cannot be used for many applications in the further-processing sector (known as converting applications), an example being the production of punched-out sections, because release papers are not dimensionally stable when exposed to moisture-level variations and moreover the thickness tolerances are often excessive. Furthermore, paper fibers deriving from the release paper adhere to the cut edges of the adhesive tape after the punching process, and this is unacceptable when the punched-out section is used for hygiene applications and electronics applications, examples being punched-out sections used in the assembly of flat screens or of mobile telephones. Applications of this type currently use siliconized polyester films of thickness 50 or 75 μm. Although they do not have the abovementioned disadvantages of release papers, they are relatively expensive and are obtainable only in colorless form for practical purposes.

When an adhesive tape which is adhesive on both sides and has been equipped with a liner is removed from the roll and its open, i.e. liner-free, adhesive-mass side is adhesive-bonded to an uneven substrate, examples being curved or embossed surfaces, tubes, or sheets with beading or rivets, it is generally impossible to achieve crease-free application of the tape. For crease-free applicability, both the adhesive tape and the liner have to be extensible, and materials used for adhesive bonding on uneven substrates are therefore inter alia liners made of polyethylene (LDPE) which is soft and extensible. However, these have two substantial shortcomings.

Firstly, when the silicone is applied to the liner it is not completely hardened, because the temperature required necessarily has to be low (by virtue of the low softening point of the base film), and low-molecular weight silicone therefore remains on the surface of the liner and reduces the adhesion of the pressure-sensitive adhesive located thereon, this being a result of subsequent transfer onto the pressure-sensitive adhesive. The release film cannot moreover be coated directly with adhesive, and the adhesive layer(s) must therefore first be applied to an auxiliary liner (for example a siliconized polyester film), and then transferred to the LDPE liner by a lamination process. This step not only has high operating costs but also produces waste in the form of the auxiliary liner.

Solvent-based pressure-sensitive adhesives cannot be coated directly onto the PE film, because it is not resistant to solvent or to heat. When a hot-melt pressure-sensitive-adhesive coating is used, the release film melts if the machine stops unexpectedly, and this causes undesired break-offs.

The heat resistance of polyethylene can be increased in order to counter these disadvantages, specifically by using a higher-density polymer, such as MDPE or HDPE, but this disadvantageously reduces the required extensibility to a fraction of the previous value.

It is an object of the invention to provide a release film which has good extensibility, which has adequate heat resistance not only for release coating but also for direct coating with pressure-sensitive adhesive, and which does not have the disadvantages mentioned of the prior art.

Said object is achieved in a manner which is surprising to, and not foreseeable by, the person skilled in the art via a release film characterized in more detail in the main claim. The dependent claims describe advantageous embodiments of the invention. The concept of the invention also encompasses the use of the release film of the invention.

Accordingly, the invention provides a release film made of an at least single-layer film structure in which there is a base film present, on which, if appropriate, there are further layers located, where a release layer has been applied to at least one side of the film structure.

The base film comprises an ethylene polymer A with a density of from 0.86 to 0.89 g/cm³ and with a crystallite melting point of at least 105° C., and also an ethylene polymer B with a density of at least 0.90 g/cm³.

In the invention, the expression ethylene polymer means a homo- or copolymer whose main component, based on weight, consists of ethylene.

The release layer(s) cover(s) the external side(s) of the film structure.

In one preferred embodiment of the invention, the proportion of ethylene polymer A, based on the entire amount of polyethylene polymers, in the base film, is from 20 to 80% by weight.

It is preferable that the base film is composed only of the ethylene polymers A and B, and it is further preferable that the base film then comprises a mixture of the two polyethylene polymers A and B in a ratio of from 1:4 to 4:1.

The use of an ethylene-based ionomer facilitates manual tearing of the base film. This is also seen in markedly reduced Elmendorf tear strength values (ASTM D1922). In another preferred embodiment of the invention, the base film therefore comprises an ethylene-containing ionomer.

When this approach is used, an adhesive tape covered with the release film of the invention can be cut to length manually during application of the adhesive tape, thus making it possible to omit any use of knives or scissors.

The mechanical properties of the release film of the invention in MD (machine direction) are preferably within the following ranges:
force at 10% tensile strain from 3 to 30 N/cm, preferably from 7 to 18 N/cm,
tensile strain at break from 50 to 800%, preferably from 200 to 400%, and/or
breaking force within the range from 10 to 50 N/cm, preferably from 15 to 35 N/cm.

In another preferred embodiment of the invention, the thickness of the film structure is from 45 to 200 μm, preferably from 75 to 125 μm.

The film structure has a release layer on one side, preferably on both sides. The known release agents can be used for this purpose (if appropriate in a form blended with further polymers). Examples are stearyl compounds (e.g. polyvinyl stearylcarbamate, stearyl compounds of transition metals, such as Cr or Zr, and ureas made of polyethyleneimine and stearyl isocyanate), polysiloxanes (e.g. in the form of copolymer with polyurethanes or with polyureas, or in the form of graft copolymer on polyolefin), and thermoplastic fluoropolymers. Preference is given to polysiloxanes with crosslinking produced by radiation processes, or by condensation processes, or by an addition reaction. Particular preference is given to vinylpolydimethyl-siloxanes crosslinked with methylhydrosiloxanes in the presence of a platinum-containing catalyst.

The release layer can be applied by a coating process, but it is also possible in the invention to coextrude the release layers with the film structure.

When a release solution containing solvent is used, the amount applied of the release layer is preferably in the range from 0.2 to 0.8 g/m². If the release agent is applied by a solvent-free method, the amount applied is preferably in the range from 1.0 to 3 g/m².

In order to improve adhesion to the surface, those sides of the film structure that are to be provided with the release layer are preferably pretreated. This can be achieved via chemical coatings or treatments derived from the gas phase (e.g. fluorine-containing gases), or via physical processes, such as flame treatment or plasma treatment, and in particular corona treatment.

It is further preferable that present on the base layer there is precisely one or preferably bilaterally two coextruded external layers made of polymers with higher crystallinity than the base layer (preferably internal layer), which inhibit blocking of the release film on wind-up of the same. The arrangement here has the external layers below the release layer(s), i.e. between base film and release.

The external layer(s) preferably use(s) a polyethylene with a density of at least 0.90 g/cm³, preferably at least 0.92 g/cm³, and optionally use a filler (anti-blocking agent). Another constituent of the external layer can be a PE ionomer, in order to improve susceptibility to manual tear. A usual thickness of the external layer(s) is about 5 to 20% of the thickness of the core layer, i.e. of the film structure.

In the invention, it is preferable that the flexural modulus of the ethylene polymer A is below 90 MPa, and that simultaneously the flexural modulus of the ethylene polymer B is at least 90 MPa.

The preferred melt index of the ethylene polymers A and B is respectively below 10 g/10 min.

It has proven advantageous that the density of the ethylene polymer A is from 0.86 to 0.88 g/cm³, and/or that the crystallite melting point is at least 115° C. It is particularly advantageous that the density of the ethylene polymer A is from 0.86 to 0.87 g/cm³.

It is further preferable that the ethylene polymer A comprises, as comonomer, a C₃-C₁₀ olefin, in particular 1-octene.

It is particularly preferable that the melt index of the ethylene polymer A is from 2 to 10 g/10 min.

In another preferred embodiment of the invention, the density of the ethylene polymer B is at least 0.92 g/cm³, preferably 0.94 g/cm³.

Examples of the ethylene polymer B are LLDPE, HDPE, MDPE, metallocene PE, EVA, EBA, and EMA, particular preference being given to MDPE and HDPE. Preference is also given to ethylene polymers having a broad or bimodal molecular weight distribution. The melt stability of said polymers thus achieves a stable blowing process.

Production of the ethylene polymers A and B can use further polyolefins, or usual additives, such as fillers, pigments, antioxidants, nucleating agents, impact modifiers, or lubricants.

The film structure, or if this is a single-layer structure, the base film, where both of these serve as a base for the release-film-production process, can be produced via calendering or preferably via extrusion, and in particular via blown-film extrusion.

The direction in which the film structure leaves the production machine is termed machine direction. Even if the release film is subsequently punched or cut to give sections, the machine direction continues to be unambiguously defined and determinable.

The release film of the invention can be used for producing labels or adhesive tapes.

It can be laminated to, or coated with, a pressure-sensitive adhesive that provides adhesive properties on both sides (to give a “substrateless” adhesive tape). The adhesive tape to be covered with the release film of the invention can also comprise a substrate, an example being a thin paper (tissue), a foil, a textile, a polyolefin foam, or a nonwoven.

It is preferable that the adhesive tape is adhesive on both sides, and it particularly preferably comprises a substrate made of thin paper, nonwoven, or foam.

Suitable pressure-sensitive adhesives are described in D. Satas, Handbook of Pressure Sensitive Adhesive Technology (3rd edition, 1999, Van Nostrand Reinhold). Particularly suitable pressure-sensitive adhesives are those based on acrylate, on natural rubber, or on thermoplastic styrene block copolymer, or polyisobutylene, or silicone. Pressure-sensitive acrylate adhesives are preferred, and these can have been applied in the form of dispersion, or of hotmelt, or from solution. The self-adhesive mass used can have been blended with one or more additives in order to optimize properties, examples being tackifiers (resins), plasticizers, fillers, pigments, UV absorbers, light stabilizers, antioxidants, crosslinking agents, crosslinking promoters, or elastomers. The adhesive layer can have been crossed via heat or via high-energy radiation.

The coating thickness of the adhesive mass on the adhesive tape substrate is preferably in the range from 18 to 200 g/m² per side, in particular from 40 to 120 g/m². If the adhesive tape has no substrate, the coating thickness of the adhesive mass on the release film is preferably in the range from 36 to 400 g/m², in particular from 80 to 240 g/m².

The general expression “adhesive tape” encompasses for the purposes of this invention all of the sheet-like structures such as films which extend in two dimensions, or film sections, tapes with extended length and restricted width, tape sections, punched-out sections, labels, and the like.

The release film of the invention is particularly advantageous when a double-sided adhesive tape, an adhesive mass of which has been covered by the release film, is unrolled and, together with the release film, adhesive-bonded with the open adhesive-mass side on uneven substrates. The mechanical properties thereof permit crease-free application of the adhesive tape.

### Test Methods

The measurements were made under the following conditions of temperature and humidity: 23±1° C. and 50±5% rel. humidity.

The density of the polymers is determined to ISO 1183 and expressed in g/cm³.

Melt index is tested to ISO 1133 using 190° C. and 2.16 kg and is expressed in g/10 min.

Crystallite melting point (T_{cr}) is determined via thin-layer chromatography (TLC) using a heating rate of 10° C./min to ISO 3146.

Flexural modulus is to be determined to ASTM D790 (secant modulus for 2% tensile strain).

The tensile strain behavior of the release film is determined on type 2 test specimens (test strips which are rectangular, 150 mm in length and (where possible) 15 mm in width) to DIN EN ISO 527-3/2/300 using a test velocity of 300 mm/min, a clamped length of 100 mm and pretensioning force of 0.3 N/cm; sharp blades were used to trim the samples used to determine the data here. Tensile strain behavior is tested in machine direction (MD, direction of running). The force is expressed in N/width of strip (in cm), and tensile strain at break is expressed in %.

Susceptibility to manual tear is difficult to express numerically, although breaking force, tensile strain at break, and tensile impact resistance (measured longitudinally) have a substantial effect. The release film is subjected to two types of tear: transversely between two thumb/index finger pairs, and then, post-application, longitudinal impulse tear.

### Evaluation:

++=good
+=workable
−=workable with difficulty
−−=tear requires excersion of large force, ends are irregular

Blocking of the film structure is assessed after 4 weeks of storage at 23° C. The test checks whether peeling of the film is
easy (+)
difficult (0) or
impossible (−).

The thickness of the film structure of the release film is determined to DIN 53370.

Examples will be used below to illustrate the invention, which is not restricted by the examples.

### EXAMPLES

### Contents

### Description of the Inventive Examples

### Tabular Collation of the Results of the Inventive Examples

### Description of the Comparative Examples

### Tabular Collation of the Results of the Comparative Examples

### Inventive Example 1

A film formulated with the following structure is produced on a blown-film plant (the layer structure within the film then being 1, 2, 3):

### Layer 1, 18 μm:

25% by weight of LD 251 (LDPE from ExxonMobil, melt index 8 g/10 min, density 0.9155 g/cm³, flexural modulus 180 MPa, crystallite melting point 104° C.)
75% by weight of Novex M21E760 (PE ionomer with Zn ions from Ineos, melt index 0.5 g/10 min, density 0.933 g/cm³, crystallite melting point 107° C., flexural modulus 200 MPa)

### Layer 2, 34 μm:

78% by weight of INFUSE D9507 (polyethylene made of ethylene and octene from Dow, density 0.866 g/cm³, melt index 5 g/10 min, flexural modulus 14 MPa, crystallite melting point 120° C.)
17% by weight of Hostalen GD9555 (HDPE from Basell, density 0.953 g/cm³, crystallite melting point 132° C., flexural modulus 1050 MPa, melt index 0.9 g/10 min)
5% by weight of Plasblack PE 1851 (carbon black masterbatch from Cabot)

### Layer 3, 18 μm:

As layer 1
Layer 2 has the constitution of the invention.

The resultant film structure is corona-treated on both sides and then stored at 23° C. for 4 weeks. Blocking is tested on unwinding.

The film structure is then respectively coated with a solution of a mixture made of
96.5 parts by weight of Dehesive 914 (vinylpolydimethylsiloxane from Wacker Silicones),
2.5 parts by weight of Crosslinker V24 (methylhydropolysiloxane from Wacker Silicones), and
1 part by weight of Catalyst OL (catalyst in polydimethylsiloxane from Wacker Silicones),
   and the coating is then hardened by passage through an oven.

The finished release film is then coated with an acrylate hotmelt adhesive, and specifically by applying the mass at 100 g/m², where the constitution of the acrylate hotmelt adhesive is as follows:
8 kg of acrylic acid
48 kg of NTBAM (N-tert-butylacrylamide)
8 kg of maleic anhydride
368 kg of 2-ethylhexyl acrylate
368 kg of n-butyl acrylate
600 kg of acetone/isopropanol (97:3)
400 g+400 g of Vazo 67® (2,2′-azobis(2-ethylpropionitrile) from DuPont)

The precise method for producing this adhesive mass can be found in the examples of DE 101 45 229 A1.

A 15 g/m² tissue (TS Tape Paper from Toyota Tsuho Corporation) is then laminated to the adhesive-mass layer and the entire material is wound to give the roll.

In a second operation, this precursor material is unwound and again analogously coated with a pressure-sensitive adhesive mass, but this time on that side of the tissue that is free from adhesive mass, and the material is then wound to give the parent roll, and cut.

The unwound adhesive tape together with the release-film covering can be applied with the open adhesive-mass side on uneven surfaces, without creasing.

### Inventive example 2

A film of thickness 150 μm made of 33% by weight of INFUSE D9507 and 67% by weight of LD 251 is produced on a blown-film plant. The resultant base film is corona-treated on both sides and then stored at 23° C. for four weeks. Blocking is tested on unwinding.

The film is then respectively coated with a solution of a mixture made of
96.8 parts by weight of SL 6670 (vinylpolydimethylsiloxane with platinum catalyst, GE Silicones), and
3.2 parts by weight of SS 4300 C (methylhydropolysiloxane, GE Silicones),
   and the coating is then hardened by passage through an oven.

The adhesive mass applied to the finished release film comprises an acrylate-solvent adhesive mass, an example being Rikidyne BDF 505 (Sankyo Chemical), with addition of Desmodur Z 4470 MPA/X (aliphatic polyisocyanate from Bayer MaterialScience), and specifically 1 part by weight for every 100 parts by weight of adhesive mass, calculated as dry content, using 50 g/m².

An LDPE film (LDPE Film 16000 red 100, weight per unit area 15 g/m², produced by Huhtamaki) was laminated to the adhesive mass.

In a second operation, this precursor material is unwound and again coated with a pressure-sensitive adhesive mass, but this time on that side of the LDPE film that is free from adhesive mass, and the material is then wound to give the parent roll, and cut.

The unwound adhesive tape together with the release-film covering can be applied with the open adhesive-mass side on uneven surfaces, without creasing.

### Properties of the Examples

| | Inventive | Inventive |
|---|---|---|
| | example 1 | example 2 |
| Film thickness [mm] | 0.07 | 0.15 |
| Force at 10% tensile strain [N/cm] | 11 | 11 |
| Susceptibility to manual tear | ++ | + |
| Film blocking | + | 0 |

### Comparative Example 1

The production process is as in inventive example 1, but INFUSE D9507 is replaced by Hostalen GD9555.

The resultant adhesive tape cannot be applied on uneven substrates without creasing.

### Comparative Example 2

The base film is produced as in inventive example 2, but LD 251 is replaced by INFUSE D9507.

Even when the film is fresh, it is difficult to unwind.

### Comparative Example 3

The base film is produced as in inventive example 2, but LD 251 and INFUSE D9507 are replaced by Exact 0203 (soft LLDPE made of ethylene and octene from DexPlastomers, density 0.902 g/cm³, melt index 3 g/10 min, flexural modulus 70 MPa, crystallite melting point 95° C.)

Even when the film is fresh, it is difficult to unwind.

### Comparative Example 4

The release film used comprises an LDPE film (LDPE Film 16000 red 100) from Huhtamaki. The coating process is carried out analogously to inventive example 1.

When the film is stopped, it tears as a result of melting. In the coating process as in inventive example 2, the release film shrinks severely, and after the first adhesive-coating process the product has severe corrugation. When the drying temperature is lowered, the adhesive coating does not dry sufficiently.

### Properties of the Comparative Examples

| | Compara- | Compara- | Compara- | Compara- |
|---|---|---|---|---|
| | tive | tive | tive | tive |
| | example 1 | example 2 | example 3 | example 4 |
| Film thickness | 0.07 | 0.15 | 0.15 | 0.09 |
| [mm] | | | | |
| Force at 10% | 33 | 1.3 | 5.0 | 11 |
| tensile strain | | | | |
| [N/cm] | | | | |
| Susceptibility | + | −− | −− | − |
| to manual tear | | | | |
| Film blocking | + | − | − | unknown |

The release film of the invention does not have the disadvantages mentioned found in release papers, in oriented release films, or in polyethylene release films.

1. A release film comprising at least single-layer film structure having a base film present, on which, further layers are optionally located, where a release layer has been applied to at least one side of the film structure, wherein
the base film comprises an ethylene polymer A, having a density of from 0.86 to 0.89 g/cm³ and a crystallite melting point of at least 105° C., and an ethylene polymer B with a density of at least 0.90 g/cm³.

2. The release film according to claim 1, wherein a proportion of ethylene polymer A is from 20 to 80% by weight, based on an entire amount of polyethylene polymers in the base film.

3. The release film according to claim 1, wherein the base film is composed only of the ethylene polymers A and B, wherein a ratio of the two polyethylene polymers A and B is from 1:4 to 4:1.

4. The release film according to claim 1, wherein the base film comprises an ethylene-containing ionomer.

5. The release film according to claim 1, wherein mechanical properties of the release film in a machine direction are within the following ranges:
force at 10% tensile strain from 3 to 30 N/cm,
tensile strain at break from 50 to 800%, and/or
breaking force within a range of 10 to 50 N/cm.

6. The release film according to claim 1, wherein a thickness of the film structure is from 45 to 200 μm.

7. The release film according to claim 1, wherein an external layer is present on the base layer, wherein the external layer inhibits blocking of the release film.

8. The release film according to claim 1, wherein a flexural modulus of the ethylene polymer A is below 90 MPa and a flexural modulus of the ethylene polymer B is at least 90 MPa, wherein a melt index of the ethylene polymers A and B is respectively below 10 g/10 min.

9. The release film according to claim 1, wherein the ethylene polymer A comprises, as comonomer, a C₃-C₁₀ olefin, wherein a density of the ethylene polymer A is from 0.86 to 0.88 g/cm³, wherein a melt index of the ethylene polymer A is from 2 to 10 g/10 min, and/or a crystallite melting point of the ethylene polymer A is at least 115° C.

10. The release film according to claim 1, wherein a density of the ethylene polymer B is at least 0.92 g/cm³.

11. The release film according to claim 1, wherein at least one of optional release coating is present on the release film and comprises a silicone.

12. A method for covering an adhesive layer of a label, a punched-out adhesive-tape section, or an adhesive tape, which has an adhesive layer on one or both sides, wherein the method comprises:
covering said adhesive layer of said label, said punched-out adhesive-tape section, or said adhesive tape with the release film according to claim 1.

13. The method according to claim 12, wherein the adhesive layer is based on acrylate.

14. The release film according to claim 5, wherein the force at 10% tensile strain for the release film is from 7 to 18 N/cm.

15. The release film according to claim 5, wherein the tensile strain at break for the release film is from 200 to 400%.

16. The release film according to claim 5, wherein the breaking force for the release film is within the range of 15 to 35 N/cm.

17. The release film according to claim 6, wherein the thickness of the film structure is from 75 to 125 μm.

18. The release film according to claim 1, wherein bilaterally two coextruded external layers are present on the base layer, wherein the external layers inhibit blocking of the release film.

19. The release film according to claim 9, wherein the C₃-C₁₀ olefin comonomer is 1-octene.

20. The release film according to claim 10, wherein the density of the ethylene polymer B is at least 0.94 g/cm³.
